(19) United States
(12) Patent Application Publication
(10) Pub. No.: US 2026/0192337 A1
(43) Pub. Date: Jul. 9, 2026

(54) SYSTEM LABELING OBJECTS ON A CONVEYOR USING MACHINE VISION MONITORING AND DATA COMBINATION

(71) Applicant: INDUSTRIES MACHINEX INC., Plessisville (CA)

(72) Inventors: Jean-Michel PARÉ, Plessisville (CA); Joel Champoux, Victoriaville (CA)

(21) Appl. No.: 18/868,330

(22) PCT Filed: Aug. 1, 2023
(86) PCT No.: PCT/CA2023/051030

§ 371 Date: Nov. 22, 2024

Related U.S. Application Data
(60) Provisional application No. 63/394,177, filed on Aug. 1, 2022.

(51) Int. Cl. B07C 5/342; G06V 10/143; G06V 10/26; G06V 10/774; G06V 10/82

(52) U.S. Cl. CPC B07C 5/342; G06V 10/143; G06V 10/26; G06V 10/774; G06V 10/82

(57) ABSTRACT

A system for monitoring a flow of residual materials on a conveyor. At least two acquisition systems over the conveyor operate with at least two distinct image acquisition spectral parameters, which may differ in spectral range and/or in type of image acquisition (normal, hyperspectral). Images are pre-processed, preferably by a computer dedicated to each acquisition system, to be cut into image fragments of a reduced size corresponding to specific objects in the flow of mixed residual materials. The image fragments are time-tagged and include data allowing material identification of the object. Reconciliation between image fragments from different acquisition systems related to the same object is based on the time-tagging. The data allowing material identification from the reconciled image fragments is used to improve accuracy of material identification, for classification or for training a neural network algorithm which is to be used for classification.

### CROSS-REFERENCE TO RELATED APPLICATIONS

This application claims priority or benefit from U.S. patent application 63/394,177, filed Aug. 1, 2022, the specification of which is hereby incorporated herein by reference in its entirety.

### FIELD OF THE INVENTION

The subject matter disclosed generally relates to methods for sorting on a conveyor. More specifically, it relates to methods for categorizing objects on the conveyor using machine vision and artificial intelligence.

### BACKGROUND

In the industry of residual material sorting, objects are typically discharged in bulk on a conveyor for sorting, including categorizing each object according to its material which dictates how it will be sorted, since recyclable materials and residual materials in general are generally sorted depending on the material from which they are made, although other properties such as size may be used for sorting.

Categorizing is also known as labelling (which is understood herein to be a categorization, unrelated to the action of putting a sticker on an object). Categorization or labelling, in the prior art, typically involve a camera or a sensor of some sort which collects data in a stream of objects (residual material) on a conveyor and uses some algorithm (expert system, AI or the like) to try to identify a material and categorize each object to act on said object (physical sorting) from that camera or sensor.

There is a need to improve the step of categorization or labelling to make it faster, more efficient, and more accurate in the identifications it can produce.

### SUMMARY

A system for monitoring a flow of residual materials on a conveyor. At least two acquisition systems over the conveyor operate with at least two distinct and different image acquisition spectral parameters, which may differ in spectral range and/or in type of image acquisition (normal, hyperspectral). Images are pre-processed, preferably by a computer dedicated to each of the at least two acquisition systems, to be cut into image fragments of a reduced size corresponding to specific objects in the flow of mixed residual materials. The image fragments are time-tagged and include data allowing material identification of the object. Reconciliation between image fragments from different acquisition systems related to the same object is based on the time-tagging. The data allowing material identification from the reconciled image fragments is used to improve accuracy of material identification, for classification or for training a neural network algorithm which is to be used for classification.

According to an aspect, there is provided a system for monitoring a flow of mixed residual materials on a conveyor comprising:
a first acquisition system located at a first location over the conveyor and comprising a first detector operating with first image acquisition spectral parameters;
a first acquisition computer for receiving first image data from the first acquisition system and performing a pre-processing on the first image data including cutting images into first image fragments of a reduced size in comparison with the first image data and corresponding to specific objects in the flow of mixed residual materials, time-tagging said first image fragments and including data allowing material identification of the object in the first image fragments;
a second acquisition system distinct from the first acquisition system, located at a second location over the conveyor and comprising a second detector operating with second image acquisition spectral parameters distinct from the first image acquisition spectral parameters;
a second acquisition computer for receiving second image data from the second acquisition system and performing a pre-processing on the second image data including cutting images into second image fragments of a reduced size in comparison with the second image data and corresponding to specific objects in the flow of mixed residual materials, time-tagging said second image fragments and including data allowing material identification of the object in the second image fragments;
sending the first image fragments and the second image fragments to a combination computer performing a reconciliation between the first image fragments and the second image fragments as being related to the same object based on the time-tagging of the first image fragments and the second image fragments, and using the data allowing material identification from both the first image fragments and the second image fragments to improve accuracy of the material identification of the object.

According to an embodiment of the disclosure, the second acquisition computer is distinct from the first acquisition computer.

According to an embodiment of the disclosure, the first acquisition computer is a camera and the first image acquisition spectral parameters comprise a type of spectral image data acquisition which is luminance-only image data acquisition in which a single luminance value is measured for each pixel in any image.

According to an embodiment of the disclosure, the first acquisition computer is a visible-light camera and the first image acquisition spectral parameters comprise a spectral range of operation covering a visible-light range between about 400 nm and about 800 nm.

According to an embodiment of the disclosure, first acquisition computer is an infrared camera and the first image acquisition spectral parameters comprise a spectral range of operation covering a visible-light range between about 700 nm and about 5 μm.

According to an embodiment of the disclosure, the second acquisition computer is a hyperspectral camera and the second image acquisition spectral parameters comprise a type of spectral image data acquisition which is hyperspectral imagery in which a spectrum is measured for each pixel in any image.

According to an embodiment of the disclosure, the second acquisition computer is a visible-light hyperspectral camera and the second image acquisition spectral parameters comprise a spectral range of operation covering a visible-light range between about 400 nm and about 800 nm.

According to an embodiment of the disclosure, the second acquisition computer is an infrared hyperspectral camera and the second image acquisition spectral parameters comprise a spectral range of operation covering an infrared range between about 700 nm and about 5 μm.

According to another aspect of the invention, there is provided a use of the system to classify objects in a flow of mixed residual materials on a conveyor.

According to another aspect of the invention, there is provided a method for monitoring a flow of mixed residual materials on a conveyor comprising:
acquiring first image data of the flow of mixed residual materials using a first acquisition system located at a first location over the conveyor and comprising a first detector operating with first image acquisition spectral parameters;
by a first acquisition computer, receiving the first image data from the first acquisition system and performing a pre-processing on the first image data including cutting images into first image fragments of a reduced size in comparison with the first image data and corresponding to specific objects in the flow of mixed residual materials, time-tagging said first image fragments and including data allowing material identification of the object in the first image fragments;
acquiring second image data of the flow of mixed residual materials using a second acquisition system distinct from the first acquisition system, located at a second location over the conveyor and comprising a second detector operating with second image acquisition spectral parameters distinct from the first image acquisition spectral parameters;
by a second acquisition computer receiving second image data from the second acquisition system and performing a pre-processing on the second image data including cutting images into second image fragments of a reduced size in comparison with the second image data and corresponding to specific objects in the flow of mixed residual materials, time-tagging said second image fragments and including data allowing material identification of the object in the second image fragments;
sending the first image fragments and the second image fragments to a combination computer performing a reconciliation between the first image fragments and the second image fragments as being related to the same object based on the time-tagging of the first image fragments and the second image fragments, and using the data allowing material identification from both the first image fragments and the second image fragments to improve accuracy of the material identification of the object.

According to an embodiment of the disclosure, the second acquisition computer is distinct from the first acquisition computer.

According to an embodiment of the disclosure, the first acquisition computer is a camera and the first image acquisition spectral parameters comprise a type of spectral image data acquisition which is luminance-only image data acquisition in which a single luminance value is measured for each pixel in any image.

According to an embodiment of the disclosure, the first acquisition computer is a visible-light camera and the first image acquisition spectral parameters comprise a spectral range of operation covering a visible-light range between about 400 nm and about 800 nm.

According to an embodiment of the disclosure, the first acquisition computer is an infrared camera and the first image acquisition spectral parameters comprise a spectral range of operation covering a visible-light range between about 700 nm and about 5 μm.

According to an embodiment of the disclosure, the second acquisition computer is a hyperspectral camera and the second image acquisition spectral parameters comprise a type of spectral image data acquisition which is hyperspectral imagery in which a spectrum is measured for each pixel in any image.

According to an embodiment of the disclosure, the second acquisition computer is a visible-light hyperspectral camera and the second image acquisition spectral parameters comprise a spectral range of operation covering a visible-light range between about 400 nm and about 800 nm.

According to an embodiment of the disclosure, the second acquisition computer is an infrared hyperspectral camera and the second image acquisition spectral parameters comprise a spectral range of operation covering an infrared range between about 700 nm and about 5 μm.

According to an embodiment of the disclosure, upon using the data allowing material identification from both the first image fragments and the second image fragments to improve accuracy of the material identification of the object, there is further provided the step of classifying the object in the flow of mixed residual materials on the conveyor.

According to an embodiment of the disclosure, upon sending the first image fragments and the second image fragments to a combination computer performing a reconciliation between the first image fragments and the second image fragments as being related to the same object based on the time-tagging of the first image fragments and the second image fragments, there is further provided the step of training a neural-network algorithm using the first image fragments and the second image fragments as inputs for the training.

According to an embodiment of the disclosure, there is further provided the step of using the neural-network algorithm, as trained, to classify the object in the flow of mixed residual materials on the conveyor and to perform sorting of the object on the conveyor.

### BRIEF DESCRIPTION OF THE DRAWINGS

Further features and advantages of the present disclosure will become apparent from the following detailed description, taken in combination with the appended drawings, in which:

FIG. 1 is a flowchart illustrating a method for monitoring a flow of mixed residual materials on a conveyor, according to an embodiment of the invention;

FIG. 2 is a cross section illustrating a system for monitoring a flow of mixed residual materials on a conveyor, according to an embodiment of the invention;

FIG. 3 is a perspective view illustrating a system for monitoring a flow of mixed residual materials on a conveyor, according to an embodiment of the invention;

FIG. 4 is a side view illustrating a system for monitoring a flow of mixed residual materials on a conveyor, according to an embodiment of the invention;

FIG. 5 is a front view illustrating a system for monitoring a flow of mixed residual materials on a conveyor, according to an embodiment of the invention;

FIG. 6 is another cross section, in the same plane as in FIG. 5, illustrating a system for monitoring a flow of mixed residual materials on a conveyor, according to an embodiment of the invention;

FIG. 7 is a picture illustrating an example of a flow of mixed residual materials on a conveyor, with materials sorted out of the flow, according to an embodiment of the invention.

It will be noted that throughout the appended drawings, like features are identified by like reference numerals.

### DETAILED DESCRIPTION

There is described below a method and a system 1 which is used to monitor objects in movement undergoing a substantially continuous flow within a well-defined environment, for example and without limitation, a flow of objects on a conveyor. In a more particular embodiment, and still without limitation, the method and system can be used to monitor objects to be recycled which are in motion on a conveyor of a residual material facility such as a recyclable object sorting facility. In comparison with the prior art, the present method and system 1 use multiple (i.e., a plurality, at least two) acquisition systems which have different or multiple types (i.e., a plurality of types, or at least two types) to diversify the nature of image data sources. A method to be able to reduce the size of data that need to be transmitted from all collected data, to synchronize and to combine the data from these at least two acquisition systems is disclosed herein.

According to an embodiment, the method and system are used more specifically to collect data and analyze the data from the flow, that is, the data collection and analysis are performed in real time, but do not necessarily need to perform the sorting. In other words, the data collection and analysis in real time are already a challenge in terms of computation and can be used to derive useful insights and advanced statistics, and very advantageously, be used to develop (to build) and/or train an algorithm to be able, then, to perform real-time sorting, without the need to resort to the present method necessarily (e.g., by using the result of the present metho to develop an efficient algorithm for labelling). In other words, the method and system 1 as described herein can be used to gather a very great size of data, analyze it in real time with appropriate treatment (as described further below), to allow for other real-time uses of the data treatment and analysis, and then build an algorithm to perform a lighter version of real-time sorting, or object virtual labelling to produce sorting instructions to be executed by actuators in the sorting facility, based on said data treatment and analysis (without necessarily needing to perform the real-time data treatment and analysis), but using the same apparatuses (such as the at least two acquisition systems (10, 11) described below.

In order to be able to label (to categorize) or to eventually sort the objects in the flow of residual materials on a conveyor, a trained algorithm based on neural networks can be used. In view of the resemblance between various objects which should nonetheless be sorted apart one from the other in view of their difference in materials, for example containers of a similar appearance made of different types of plastics, the training of the neural network was found to be very hard, especially when the source of data is a camera.

According to the present disclosure, it was found that the combination of data from acquisition systems of different types reduces the time and data needed for the training of the neural-network algorithm, while also improving the sensitivity/accuracy of the labelling performed by the algorithm. However, it was also found that using two or more acquisition systems, as contemplated herein, creates a problem of managing and treating greater amounts of data which makes the combination of data from different acquisition systems and the subsequent analysis difficult to perform in real time. Moreover, the required acquisition systems are typically large devices, which therefor monitor different areas of a conveyor, which implies that the data (such as image data) need to be reconciled afterwards because the same objects are monitored at different locations and at different times and need to be recognized and time-tagged at pretreatment to be able to correlate the same objects from the different acquisition systems and be able to then combine the data as collected and, therefrom, identify the material and label the objects for eventual sorting (or other actions or analyses such as statistics, anticipation, prevention/maintenance, etc.).

According to an embodiment, there is a facility comprising a production line with a conveyor for setting the objects in motion thereon. At a first specific location over the conveyor, there is provided one of the at least two acquisition systems (10, 11) to collect data on the flow of objects in motion. At a second specific location over the conveyor, there is provided a second one of the at least two acquisition systems (10, 11) to collect data on the flow of objects in motion. If there are more than two acquisition systems, there would be provided each additional acquisition system at a corresponding dedicated location in a similar manner, such that each of the at least two acquisition systems (or at least three in this case) has its own space to visually monitor the contents on the conveyor. In addition to at least two acquisition systems (10, 11) comprising two different types of cameras operating on different ranges, additional acquisition systems (if any) may include other types of sensors which may be other than cameras (e.g., all sorts of sensors which measure physical quantities or properties on objects).

Prior art systems that perform identification, labelling (i.e., virtual labelling or classification by a computing system) and sorting or mixed material sorting of residual materials are typically comprise a single (or single-type) image sensor, therefore without multiple sources of image sensors and also without any synchronization between sources as that would be useless if there are no multiple sources.

Having a plurality of image data sensors and synchronizing them, including all preprocessing necessary to make this synchronizing and any further analysis possible, ensures that a richer data set can be used to have an algorithm that can learn/train faster, and when trained, can identify or virtually label objects, such as in the context of a mixed material sorting of residual materials, in a more rapid and efficient manner in real time. Using a richer original data set, including various wavelengths of image acquisition, also ensures a better identification of the material of the residual material object, that is the accuracy of the labelling is increased to remove errors in the sorting of the residual materials on the conveyor. By using multiple data sources to improve material identification of objects on the conveyor, an algorithm can be built and reused in other facilities with the same equipment, which leads to faster operation starting time of new facilities, for example.

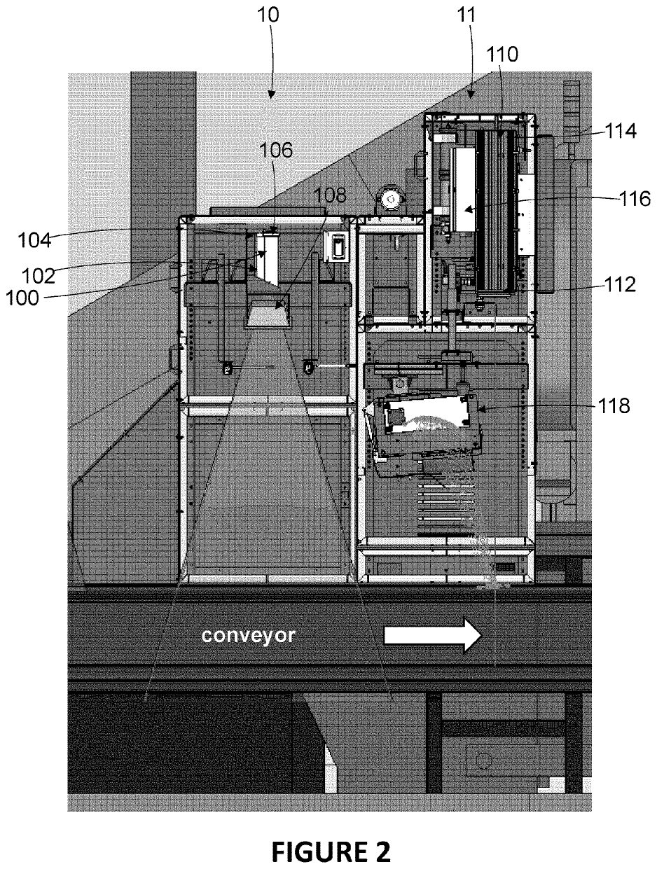

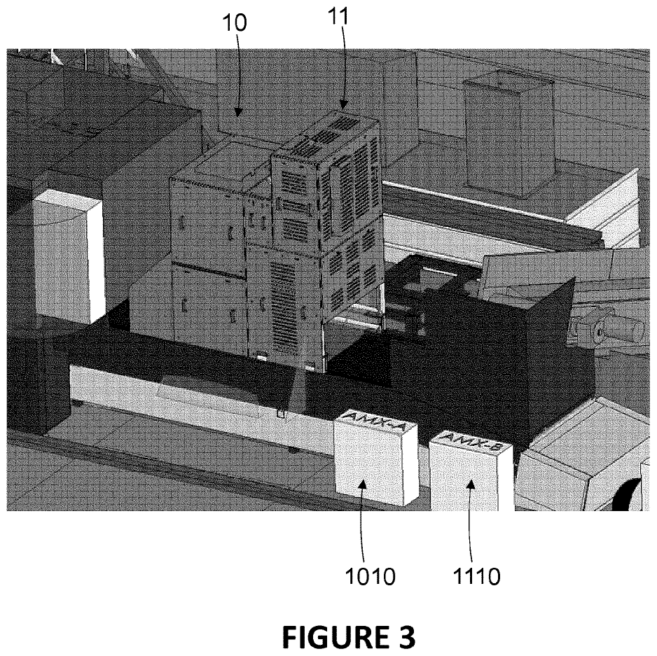

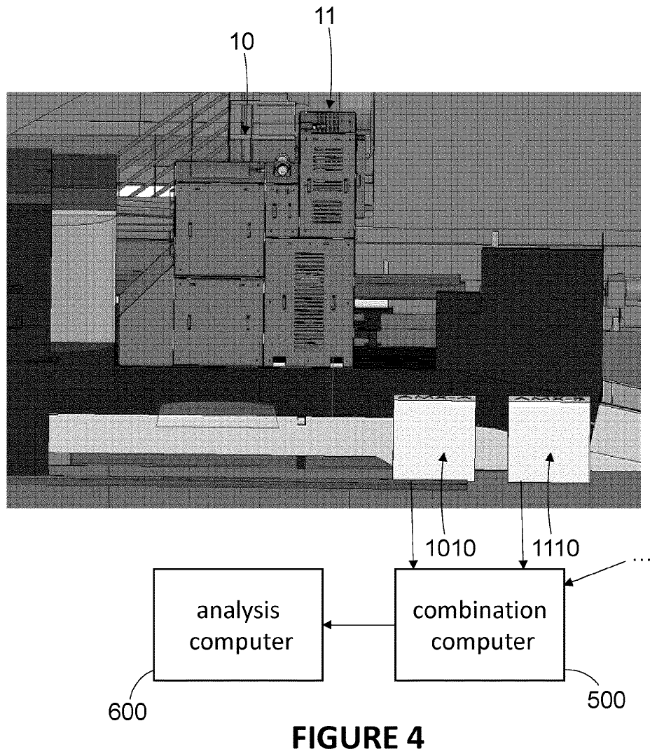

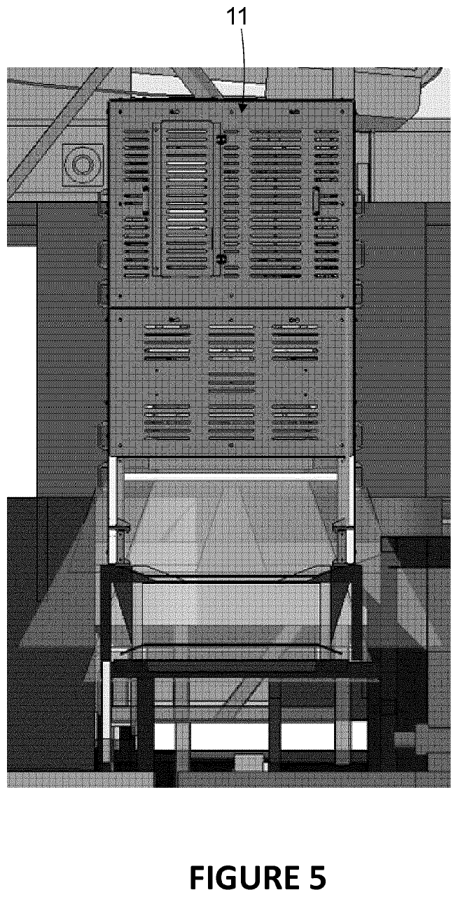

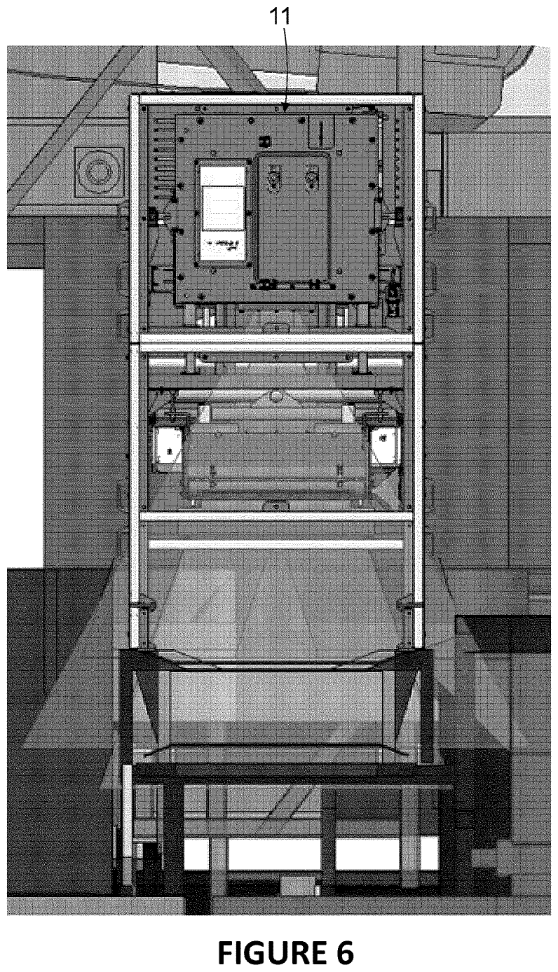

According to an embodiment of the disclosure, and referring to FIGS. 2-6, there are provided at least two acquisition systems, that is more than one. Also, the at least two acquisition systems are distinct ones, i.e., not part of the same acquisition system, but rather separate ones, each operating independently from the other and being distinct apparatuses or devices. Also, preferably, the at least two acquisition systems should be of at least two different types of acquisition systems, that is they should not only be separate, but should also be of different types. For example, according to a preferred embodiment, there are provided two acquisition systems, one of which is a camera (e.g., a camera operating in the visible light range as normally understood) and and the other one of which is a hyperspectral camera, as described in greater detail below.

According to an embodiment of the disclosure, more than two cameras or detectors (which are distinct from each other and may be of different ypes) can be used, for example at another location in a facility or to cover a wider conveyor, for example, and the additional cameras can be of either one of these types, or can be of another type, to be able to collect additional, different data to be able to extract additional insights from this richer data source.

For example, according to an embodiment of the disclosure, one of the at least two acquisition systems (10, 11) comprises a visible-light range camera 100. The camera 100 should comprise optical elements 102 (lenses), an appropriate light detector 104, and electronic components 106 which can convert the signal from the light detector 104 to a computer 1010. A dedicated lighting apparatus 108 should also be provided to illuminate (with visible-range lighting) the objects to be monitored on the conveyor. According to an embodiment of the disclosure, the computer 1010 associated to the camera 100 is a dedicated acquisition computer 1010 which is dedicated to the task of receiving in real time the collected data from the camera 100 and applying a specific treatment on the data to reduce the size of the data in order to forward the reduced amount of data, also in real time, to another (distinct and separate) computer 500 for data combination.

Similarly, a second one of the at least two acquisition systems (10, 11) comprises a hyperspectral camera 110. The hyperspectral camera 110 should comprise optical elements 112 (lenses), an appropriate light detector 114, and electronic components 116 which can convert the signal from the light detector 114 to a computer 1110. A dedicated lighting apparatus 118 should also be provided to illuminate (with multiple-range lighting which should differ from the visible-range lighting in that it should at least include other ranges or wavelengths, being more than and/or less than the visible light range of the camera 100 in terms of spectral range coverage) the objects to be monitored on the conveyor. According to an embodiment of the disclosure, the computer 1110 associated to the hyperspectral camera 110 is a dedicated acquisition computer 1110 which is dedicated to the task of receiving in real time the collected data from the camera 110 and apply a specific treatment on the data to reduce the size of the data in order to also forward the reduced amount of data, also in real time, to said other (distinct and separate) computer 500 for data combination.

According to an embodiment of the disclosure, other examples of the image sensor or other type of sensor in the different types of acquisition sensors may include, without limitation, infrared image sensors in the wavelength range between about 700 nm and about 5 μm; infrared hyperspectral image sensors in the wavelength range between about 700 nm and about 5 μm; image sensors in a visible range, e.g., between about 400 nm and about 800 nm; hyperspectral image sensors in a visible range, e.g., between about 400 nm and about 800 nm; electromagnetic sensor which determines electromagnetic properties (e.g., electric conductivity and/or magnetic permeability) of objects; sound or ultrasound sensors; ultraviolet range image sensors; ultraviolet hyperspectral image sensors, X-ray image sensors, 3D cameras, etc.

The image sensor and the hyperspectral sensor may have the same spectral range (detectable range of wavelengths, from a minimum to a maximum), or different ones, overlapping or non-overlapping. In the case where the spectral range is the same, the collected image is different because the type of acquisition of the spectrum is different. Image sensors of typical cameras (such as a typical charge-coupled device or CCD) have a spectral range of operation which corresponds to the spectral range of light that is detectable and that contributes to the lighting of a given pixel in the image. For each image (each frame), a pixel is subject to a measurement and the measurement corresponds to the total luminance of that specific pixel from all light in the detectable spectral range. A filter or splitter is typically applied to filter-out some wavelengths for a given pixel to be able to capture color differentiation from one pixel to another (such as the typical red-green-blue arrangement). Each pixel, while being dedicated to a given color, nonetheless measures a single value, i.e., total luminance across the spectral range of operation, although that luminance value may be attributed to a given color depending on the optical filter applied to that pixel.

A hyperspectral sensor differs from the typical image sensor in that it collects the whole spectrum (a graph of luminance vs wavelength) across that spectral range for each pixel. Therefore, each pixel in the camera acts as a spectrometer. Each pixel of an image (frame) includes a spectrum (graph of luminance vs wavelength), which can be stored in discrete numerical ranges, and therefore, each image is encoded as a three-dimensional matrix. The spectral range of operation is the range of wavelengths across with a spectrum is measured. As mentioned above, the image sensor and the hyperspectral sensor may have the same spectral range (detectable range of wavelengths, from a minimum to a maximum), or different ones, overlapping or non-overlapping, but in any case, the resulting data measurements will always be different because the acquired spectral data is different, the camera measuring total luminance per pixelk (optionally color-filtered for each individual pixel, such as RGB-filtered).

Any acquisition system is characterized by spectral image data acquisition parameters including: 1) a spectral range of operation and 2) a type of spectral image data acquisition. The spectral range of operation may be as described herein. The type of spectral image data acquisition may be luminance image data acquisition (optionally color-filtered for each pixel), in which case no spectrum is measured; or hyperspectral image data acquisition, in which case a spectrum is measured for each pixel. Other types of spectral image data acquisition can be contemplated.

According to an exemplary embodiment of the disclosure, the hyperspectral camera 110 and the hyperspectral acquisition system 11 in general can be such as described in U.S. Pat. No. 9,316,596. For example, and according to an embodiment, the illumination and detection can be performed in wavelength ranges such as near infrared (NIR, e.g., between about 400 nm and about 1000 nm, and/or SWIR such as between about 1000 nm and about 2700 nm).

According to an embodiment, the acquisition systems (10, 11 or more) can be installed over the conveyor and cover the width thereof, or a significant fraction of the width thereof. Otherwise, more than one acquisition systems may be provided side-by-side over the conveyor to cover the whole width if the conveyor is too large for one. For example, an acquisition system (10, 11) can be installed to cover and monitor a conveyor of a width between about 60 cm and about 400 cm.

The conveyor speed and therefore the flow of residual materials can be expected to be between about 0.25 m/s and about 5 m/s. In view of this speed, which is significant, the speed of the flow of residual materials is high enough to justify a preprocessing of the image data acquired by the acquisition systems to be able to combine all the data from diverse acquisition systems in real time and analyze the combined data.

According to an embodiment of the disclosure, each of the at least two acquisition systems (10, 11) collects its own data independently from each other, but also individually encodes the independently-collected data. This independent encoding comprises at least a step of time-stamping each picture to ensure that the collected images have a particular time stamp to be able to combine various data sources (from the at least two acquisition systems) afterwards in a consistent manner. This combination is performed after acquisition, assuming that the data collection from the at least two acquisition systems have time stamps over a time range which has an overlap between the at least two acquisition systems.

According to an exemplary embodiment, each of the at least two acquisition systems (10, 11) has its own acquisition computer, which can perform said encoding, although time-stamping of original images can or should be performed by the cameras 110, 111 themselves. However, each computer dedicated to its corresponding acquisition system can perform additional encoding, including encoding of parts of images. Indeed, the original images are normally of a size which is too large for sending them over to another computer for analysis in real time. Therefore, the acquisition computers should each independently cut the collected images as part of a step of preprocessing and which should cut out specific objects in an image. This identification and isolation of objects in images can be used by machine learning algorithms and other artificial intelligence algorithms, for example, either on a given image or over a few of successive frames. This preprocessing may therefore include splitting an image into a plurality of image fragments presumably with isolated objects thereon, each image fragment being an isolated object; other types of preprocessing may include cropping, dropping frames in the video, reducing image definition on the whole picture or in specific fragments, etc. Each fragment should be properly encoded not only with time-stamping inherited from the original picture (or the original acquisition system) from which it comes, but also other type of information embedded in these computer objects which would be used to locate, to identify and to recognize objects viewed from different ones of the acquisition systems. According to another exemplary embodiment, a computer of sufficient processing capacity may be able to perform the acquisition of data from more than one detector.

With images, parts of images, and/or modified (preprocessed) images or parts of images which are properly reduced in size (from a data perspective) and also properly encoded with information that can allow reconciliation with other data sources, the combination of data sources from the acquisition computers can take place.

The combination computer 500 is provided to receive preprocessed images, actively lowered in size and encoded for reconciliation of identified objects between different acquisition systems, including synchronizing the flow of images to be used together and that were acquired by different acquisition systems. The preprocessed data can be pushed by the acquisition computers 1010, 1110 to the combination computer 500. The combination computer 500 should therefore be connected in a wired or wireless fashion with each of the acquisition computers from which it receives preprocessed data. For greater rapidity, the combination computer 500 should be located in the facility or close to it to avoid network delays and improve real-time combination. However, if the data is transferred over the internet, it is still possible to have the combination computer 500 provided remotely, for example as a remote server or in the cloud, without limitation. The combination should include using time stamps, and expected time of motion of an object between different acquisition systems, to unambiguously identify an object from different images taken at different times by different acquisition systems as being the same object. Therefore, any of the acquisition computers (1010, 1110, or any other one) or combination computer 500 should include communication to real-time operating parameters of the sorting system, e.g., to be able to collect the conveyor speed in real-time and correlate with time stamps on the images collected by different acquisition systems located downstream or upstream any other one.

According to an embodiment, the combination computer 500 may include or communicate with an analysis computer 600 (i.e., it can be distinct or integral with the combination computer 500), such as a SCADA (Supervisory Control And Data Acquisition) system, without limitation. The analysis computer 600 may perform different tasks such as: real-time analysis of the flow to perform the labelling, optionally generating instructions for actuation of sorting devices in the production system to sort specific objects by diverting them away from the conveyor into a second, different conveyor or into a chute; using the combined data to make predictions about the flow or to make evaluations or statistics about the composition or quality of the flow of mixed residual materials; using the combined data to train an algorithm to be reused later, as pretrained, in the production facility for rapid sorting, etc. The analysis computer 600 can be located in the facility or be remote, for example a remote server or implemented in a cloud computing environment.

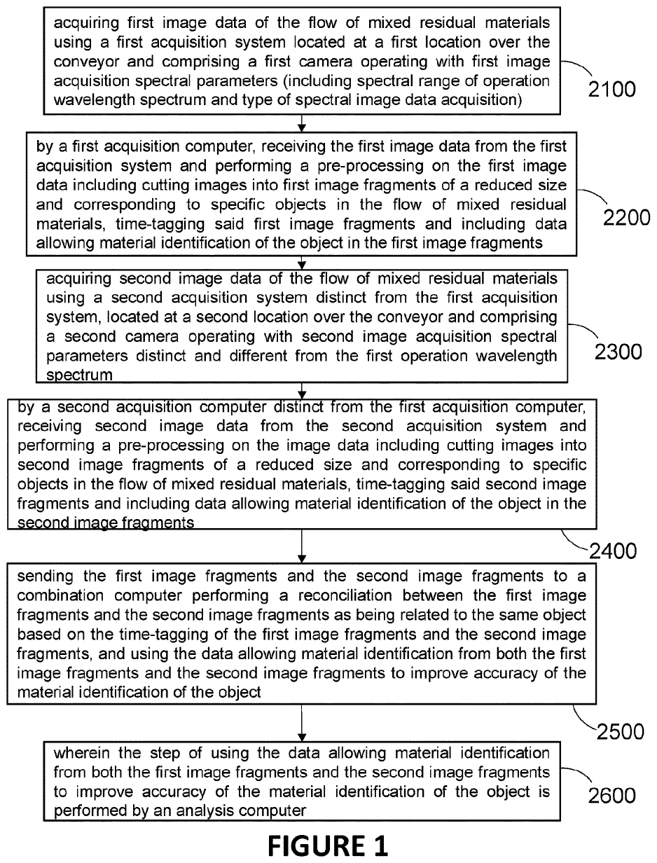

In other words, and referring to the flowchart of FIG. 1, there is the shown a method for monitoring a flow of mixed residual materials on a conveyor comprising the steps of:
Step 2100—acquiring first image data of the flow of mixed residual materials using a first acquisition system located at a first location over the conveyor and comprising a first detector (for example the detector of a camera or other type of sensor) operating with first image acquisition spectral parameters (including spectral range of operation and type of spectral image data acquisition);
Step 2200—by a first acquisition computer, receiving the first image data from the first acquisition system and performing a pre-processing on the first image data including cutting images into first image fragments corresponding to specific objects in the flow of mixed residual materials, time-tagging said first image fragments and including data allowing material identification of the object in the first image fragments;
Step 2300—acquiring second image data of the flow of mixed residual materials using a second acquisition system distinct from the first acquisition system, located at a second location over the conveyor and comprising a second detector (for example the detector of a camera or other type of sensor) operating with second image acquisition spectral parameters (including spectral range of operation and type of spectral image data acquisition)distinct and different from the first image acquisition spectral parameters;
Step 2400—by a second acquisition computer distinct from the first acquisition computer, receiving second image data from the second acquisition system and performing a pre-processing on the image data including cutting images into second image fragments corresponding to specific objects in the flow of mixed residual materials, time-tagging said second image fragments and including data allowing material identification of the object in the second image fragments;
Step 2500—sending the first image fragments and the second image fragments to a combination computer performing a reconciliation between the first image fragments and the second image fragments as being related to the same object based on the time-tagging of the first image fragments and the second image fragments, and using the data allowing material identification from both the first image fragments and the second image fragments to improve accuracy of the material identification of the object;
Step 2600—wherein the step of using the data allowing material identification from both the first image fragments and the second image fragments to improve accuracy of the material identification of the object is performed by an analysis computer.

The method is also applicable with more than two detectors which acquire images. The data from the more than two distinct detectors (for example, 3, 4, 5, 6, or more detectors) can then be treated and combined in a manner similar as with only a first and a second detector as described above.

Upon performing such classification, or simply upon collecting and combination such data based on the synchronous image fragments from objects being classified, the training of the neural-network algorithm may be made using such “labelling” or classification data correspondence between combinations of image fragments and corresponding object or material classification. Once trained using this data, the neural-network algorithm may then be applied on a real-life situation involving a flow of material on a conveyor with objects thereon to be classified, only the already trained neural-network algorithm can operate much more efficiently as it is already trained.

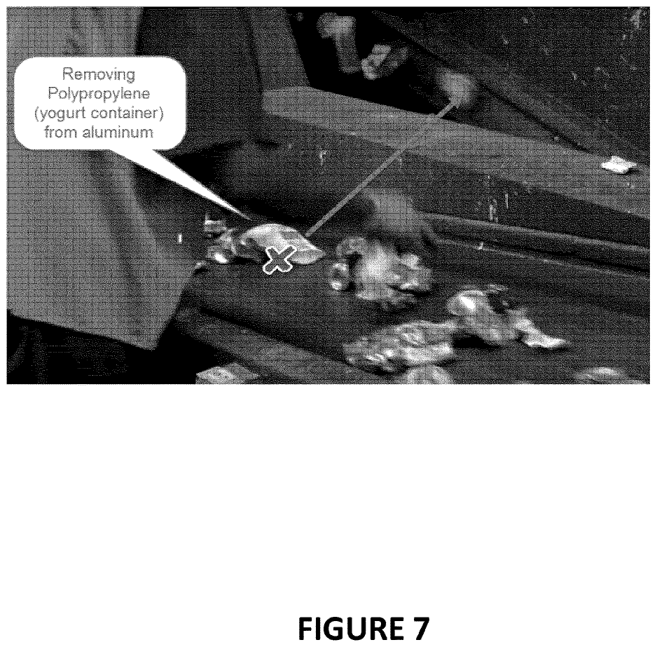

According to an exemplary embodiment of the disclosure, materials to be monitored by the acquisition systems may include paper, fiber, mixed plastics, plastic film, aluminum, HDPE, PET, TetraPak™, foil, PCV. For example, and referring to FIG. 7, in an aluminum feed (material flow), the following objects/materials can be seen and need to be sorted out: HDPE, PET, TetraPak™, foil, fiber, mixed plastics, plastic film, etc. This figure is contextual since the method of the present disclosure relates to labelling and not to actual mechanical sorting out of materials; however, the labelling or categorization is done in a context where objects are on a conveyor such as a conveyor in which mechanical sorting out of objects can eventually be performed.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A system for monitoring a flow of mixed residual materials on a conveyor comprising:
a first acquisition system located at a first location over the conveyor and comprising a first detector operating with first image acquisition spectral parameters;
a first acquisition computer for receiving first image data from the first acquisition system and performing a pre-processing on the first image data including cutting images into first image fragments of a reduced size in comparison with the first image data and corresponding to specific objects in the flow of mixed residual materials, time-tagging said first image fragments and including data allowing material identification of the object in the first image fragments;
a second acquisition system distinct from the first acquisition system, located at a second location over the conveyor and comprising a second detector operating with second image acquisition spectral parameters distinct from the first image acquisition spectral parameters;
a second acquisition computer for receiving second image data from the second acquisition system and performing a pre-processing on the second image data including cutting images into second image fragments of a reduced size in comparison with the second image data and corresponding to specific objects in the flow of mixed residual materials, time-tagging said second image fragments and including data allowing material identification of the object in the second image fragments;
sending the first image fragments and the second image fragments to a combination computer performing a reconciliation between the first image fragments and the second image fragments as being related to the same object based on the time-tagging of the first image fragments and the second image fragments, and using the data allowing material identification from both the first image fragments and the second image fragments to improve accuracy of the material identification of the object.

2. The system of claim 1, wherein the second acquisition computer is distinct from the first acquisition computer.

3. The system of claim 1 or 2, wherein the first acquisition computer is a camera and the first image acquisition spectral parameters comprise a type of spectral image data acquisition which is luminance-only image data acquisition in which a single luminance value is measured for each pixel in any image.

4. The system of claim 3, wherein the first acquisition computer is a visible-light camera and the first image acquisition spectral parameters comprise a spectral range of operation covering a visible-light range between about 400 nm and about 800 nm.

5. The system of claim 3, wherein the first acquisition computer is an infrared camera and the first image acquisition spectral parameters comprise a spectral range of operation covering a visible-light range between about 700 nm and about 5 μm.

6. The system of any one of claims 1 to 5, wherein the second acquisition computer is a hyperspectral camera and the second image acquisition spectral parameters comprise a type of spectral image data acquisition which is hyperspectral imagery in which a spectrum is measured for each pixel in any image.

7. The system of claim 6, wherein the second acquisition computer is a visible-light hyperspectral camera and the second image acquisition spectral parameters comprise a spectral range of operation covering a visible-light range between about 400 nm and about 800 nm.

8. The system of claim 6, wherein the second acquisition computer is an infrared hyperspectral camera and the second image acquisition spectral parameters comprise a spectral range of operation covering an infrared range between about 700 nm and about 5 μm.

9. Use of the system according to any one of claims 1 to 8 to classify objects in a flow of mixed residual materials on a conveyor.

10. A method for monitoring a flow of mixed residual materials on a conveyor comprising:
acquiring first image data of the flow of mixed residual materials using a first acquisition system located at a first location over the conveyor and comprising a first detector operating with first image acquisition spectral parameters;
by a first acquisition computer, receiving the first image data from the first acquisition system and performing a pre-processing on the first image data including cutting images into first image fragments of a reduced size in comparison with the first image data and corresponding to specific objects in the flow of mixed residual materials, time-tagging said first image fragments and including data allowing material identification of the object in the first image fragments;
acquiring second image data of the flow of mixed residual materials using a second acquisition system distinct from the first acquisition system, located at a second location over the conveyor and comprising a second detector operating with second image acquisition spectral parameters distinct from the first image acquisition spectral parameters;
by a second acquisition computer receiving second image data from the second acquisition system and performing a pre-processing on the second image data including cutting images into second image fragments of a reduced size in comparison with the second image data and corresponding to specific objects in the flow of mixed residual materials, time-tagging said second image fragments and including data allowing material identification of the object in the second image fragments;
sending the first image fragments and the second image fragments to a combination computer performing a reconciliation between the first image fragments and the second image fragments as being related to the same object based on the time-tagging of the first image fragments and the second image fragments, and using the data allowing material identification from both the first image fragments and the second image fragments to improve accuracy of the material identification of the object.

11. The method of claim 10, wherein the second acquisition computer is distinct from the first acquisition computer.

12. The method of claim 10 or 11. wherein the first acquisition computer is a camera and the first image acquisition spectral parameters comprise a type of spectral image data acquisition which is luminance-only image data acquisition in which a single luminance value is measured for each pixel in any image.

13. The method of claim 12, wherein the first acquisition computer is a visible-light camera and the first image acquisition spectral parameters comprise a spectral range of operation covering a visible-light range between about 400 nm and about 800 nm.

14. The method of claim 12, wherein the first acquisition computer is an infrared camera and the first image acquisition spectral parameters comprise a spectral range of operation covering a visible-light range between about 700 nm and about 5 μm.

15. The method of any one of claims 10 to 14, wherein the second acquisition computer is a hyperspectral camera and the second image acquisition spectral parameters comprise a type of spectral image data acquisition which is hyperspectral imagery in which a spectrum is measured for each pixel in any image.

16. The method of claim 15, wherein the second acquisition computer is a visible-light hyperspectral camera and the second image acquisition spectral parameters comprise a spectral range of operation covering a visible-light range between about 400 nm and about 800 nm.

17. The method of claim 15, wherein the second acquisition computer is an infrared hyperspectral camera and the second image acquisition spectral parameters comprise a spectral range of operation covering an infrared range between about 700 nm and about 5 μm.

18. The method of any one of claims 10 to 17, further comprising, upon using the data allowing material identification from both the first image fragments and the second image fragments to improve accuracy of the material identification of the object:
classifying the object in the flow of mixed residual materials on the conveyor.

19. The method of any one of claims 10 to 17, further comprising, upon sending the first image fragments and the second image fragments to a combination computer performing a reconciliation between the first image fragments and the second image fragments as being related to the same object based on the time-tagging of the first image fragments and the second image fragments,
training a neural-network algorithm using the first image fragments and the second image fragments as inputs for the training.

20. The method of claim 19, further comprising using the neural-network algorithm, as trained, to classify the object in the flow of mixed residual materials on the conveyor and to perform sorting of the object on the conveyor.
